(19) United States
(12) Patent Application Publication
(10) Pub. No.: US 2014/0295792 A1
(43) Pub. Date: Oct. 2, 2014

(54) METHODS AND APPARATUSES FOR CONTROLLING NETWORK SERVICE ACCESS FOR DISTRACTED DRIVER LOCKOUT

(71) Applicant: Alcatel-Lucent USA Inc., Murray Hill, NJ (US)

(72) Inventors: Steven MAKOWSKI, Sahuarita, AZ (US); Carl SPIES, La Fox, IL (US)

(73) Assignee: Alcatel-Lucent USA Inc., Murray Hill, NJ (US)

(21) Appl. No.: 13/852,460

(22) Filed: Mar. 28, 2013

(51) Int. Cl. H04W 48/04

(52) U.S. Cl. CPC H04W 48/04
USPC 455/411

(57) ABSTRACT

In a method for controlling network service access by a mobile device, the mobile device detects a proximity device within range of the mobile device, and controls network service access based on movement of the mobile device while the mobile device is within range of the proximity device. In another method, a network entity obtains distracted driver information associated with the mobile device in response to a network service access request, determines whether the mobile device is within range of a proximity device, and controls network service access by the mobile device based on the distracted driver information associated with the mobile device while the mobile device is within range of the proximity device.

### BACKGROUND

Operators of vehicles such as automobiles who use a mobile communication device to talk, text, watch videos, etc. while operating the vehicle may become distracted. As such, the operators may become hazardous to themselves as well as those around them.

### SUMMARY

Example embodiments relate to methods and apparatuses for controlling network service access by one or more mobile devices in a wireless communications network.

Example embodiments provide mechanisms for disabling a motor vehicle operator's mobile device from functioning when inside a vehicle that is moving and the device is in proximity of the driver position.

At least one example embodiment provides a method for controlling network service access. According to at least this example embodiment, the method includes: detecting, by the mobile device, a proximity device within range of the mobile device; and controlling, by the mobile device, network service access based on movement of the mobile device while the mobile device is within range of the proximity device.

At least one example embodiment provides a method for controlling network service access. According to at least this example embodiment, the method includes: obtaining, at a network entity, distracted driver information associated with the mobile device in response to a network service access request, the distracted driver information including movement information for the mobile device; determining whether the mobile device is within range of a proximity device; and controlling network service access by the mobile device based on the distracted driver information associated with the mobile device while the mobile device is within range of the proximity device.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates a portion of a network architecture including a signal flow diagram illustrating a method for controlling network service access according to an example embodiment.

FIG. 2 illustrates a portion of a network architecture including a signal flow diagram illustrating a method for controlling network service access according to another example embodiment.

FIG. 3A is a flow chart illustrating an example embodiment of a method for controlling network service access at a mobile device corresponding to the signal flow diagram shown in FIG. 1.

FIG. 3B is a flow chart illustrating an example embodiment of a method for controlling network service access at a mobile device corresponding to the signal flow diagram shown in FIG. 2.

FIG. 4 is a flow chart illustrating a method for controlling network service access at a mobile device according to yet another example embodiment.

FIG. 5 illustrates a portion of a network architecture including a signal flow diagram illustrating a method for controlling network service access according to still another example embodiment.

FIG. 6 illustrates a portion of a network architecture including a signal flow diagram illustrating a method for controlling network service access according to another example embodiment.

FIG. 7A is a flow chart illustrating an example embodiment of a method for controlling network service access at the network corresponding to the signal flow diagram shown in FIG. 5.

FIG. 7B is a flow chart illustrating an example embodiment of a method for controlling network service access at the network corresponding to the signal flow diagram shown in FIG. 6.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

While example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements (e.g., base stations, radio network controllers, etc.) and/or mobile devices. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing”, “computing”, “calculating”, “determining”, “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

One or more example embodiments provide mechanisms to selectively disable a motor vehicle operator's mobile device from functioning when inside a moving vehicle. In one example embodiment the network service access by the mobile device is selectively restricted and/or disabled when the mobile device is within range of a proximity device in a vehicle, and the vehicle is moving at a speed that is greater than or equal to a threshold speed.

Example embodiments may selectively restrict voice calls, data calls, text messages, any combinations of calls and/or messages or any other distracting activities on a mobile device. Emergency calls or network service access requests associated with emergency situations will always be allowed.

As discussed herein, network service refers to a service that provides or involves a communication path from a wireless network to a mobile device. Examples of network services include connections associated with: voice calls, data calls, provision of multimedia services, text messages, any combinations of calls and/or messages, or any other distracting activities on a mobile device.

Network origination refers to an operation in which the mobile device requests network services; that is, network service access originated at the mobile device.

Network termination refers to an operation in which an outside network (e.g., a public network) requests connection to the mobile device for voice, data, short message service (SMS), provision of multimedia, etc.

According to at least some example embodiments, messages (e.g., network service access request messages, network service access response messages, etc.) may be sent via radio-frequency (RF) interfaces between the mobile device and the network via any suitable communications protocol, including, for example, Global System for Mobile communications (GSM), code division multiple access (CDMA), CDMA2000, 3^{rd} Generation Partnership Project (3GPP) or 3GPP2, 3GPP LTE, 4^{th} Generation standards, etc. In at least one example embodiment, the messages may be transmitted via any suitable control signaling methodology.

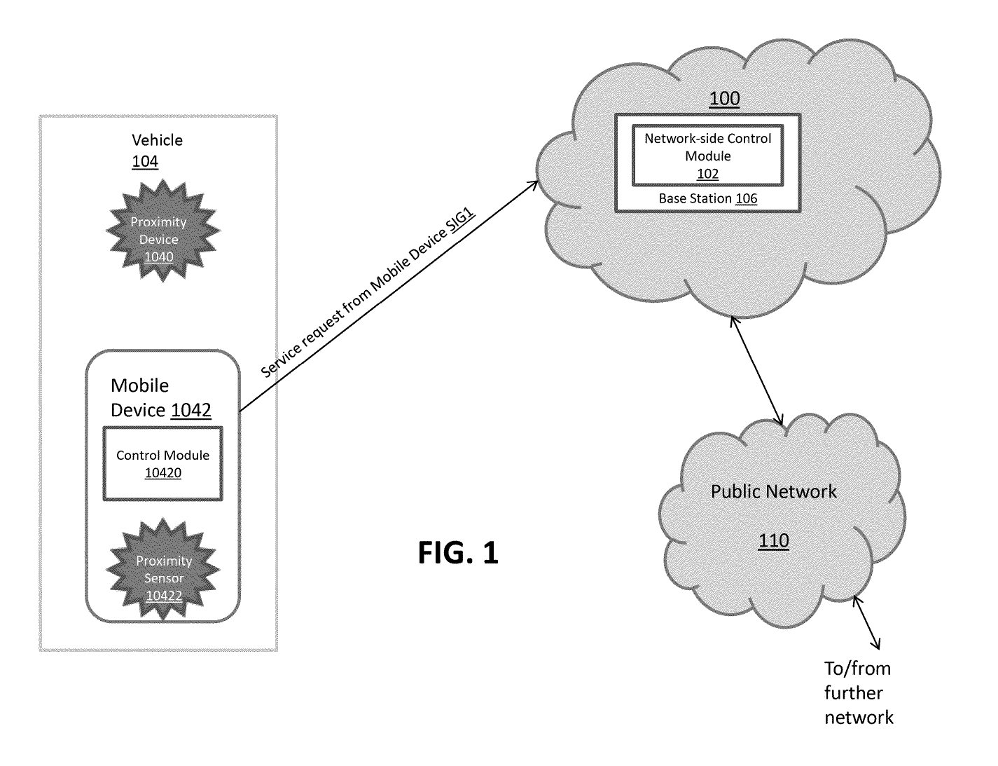

FIG. 1 illustrates a portion of a network architecture including a signal flow diagram illustrating a method for controlling network service access according to an example embodiment.

Referring to FIG. 1, the mobile device 1042 includes a network service access control module (hereinafter referred to as “control module”) 10420 and a proximity sensor 10422. The control module 10420 is operatively coupled to the proximity sensor 10422. In addition to the components shown in FIG. 1, the mobile device 1042 includes conventional components providing conventional functionality that is well-known in the art.

As discussed herein, the term “mobile device,” may be considered synonymous to, and may hereinafter be occasionally referred to, as a client, mobile unit, mobile device, mobile user, mobile, subscriber, user, remote station, access terminal, receiver, etc. As described herein, a mobile device describes a remote user of wireless resources and/or network services in a wireless communications network. The mobile device may be, for example, a cell phone, smartphone, tablet, laptop computer, video gaming device, media player, or the like that is capable of voice, video, text, data transmission and/or any other activity that may distract an operator of a motor vehicle.

In FIG. 1, the mobile device 1042 is located within a vehicle 104, which includes a proximity device 1040. The vehicle 104 may be an automobile, truck, train, or any similar machine or vehicle.

The proximity sensor 10422 and the proximity device 1040 form a monitoring or proximity detection system that determines the position of the mobile device 1042 relative to the driver's position in the vehicle 104. In one example, the proximity device 1040 may be arranged in the vehicle 104 such that the proximity sensor 10422 is within range of the proximity device 10422 when the user is in the driver's seat of the vehicle 104. In this example, the proximity sensor 10422 is able to detect or sense when the user of the mobile device 1042 is operating the vehicle 104.

The proximity device 1040 may be located such that its impact is limited only to the driver's position, and not passengers in the vehicle. In this regard, the proximity device 1040 may be positioned in front and to the left of the driver's position (e.g., embedded in the dashboard, in the visor, steering wheel, driver's seat headrest or seat, ceiling of the vehicle, etc.). A short range proximity device may be utilized to achieve this end.

According to at least one example embodiment, a passive or active radio frequency identification (RFID) tag and tag reader is one possible implementation of the proximity device 1040 and proximity sensor 10422, respectively. In this example, the proximity sensor 10422 may be integrated into the mobile device 1042, and the processor or processors of the mobile device 1042 may be configured to control and interpret information from the proximity sensor 10422. Because proximity systems such as this are generally well-known, a more detailed description is omitted.

Still referring to FIG. 1, the mobile device 1042 is configured to communicate with a wireless network 100. The wireless network 100 may include a radio access network (RAN) such as: Universal Mobile Telecommunications System (UMTS); Global System for Mobile communications (GSM); Advance Mobile Phone Service (AMPS) system; the Narrowband AMPS system (NAMPS); the Total Access Communications System (TACS); the Personal Digital Cellular (PDC) system; the United States Digital Cellular (USDC) system; the code division multiple access (CDMA) system described in EIA/TIA IS-95; a High Rate Packet Data (HRPD) system, Worldwide Interoperability for Microwave Access (WiMAX); Ultra Mobile Broadband (UMB); and 3^{rd} Generation Partnership Project LTE (3GPP LTE).

The RAN includes, inter alia, a base station or NodeB 106 that provides radio access to mobile devices within a given coverage area. This coverage area is referred to as a cell. As is known, a RAN includes other entities such as a radio network controller (RNC) and the like, which are omitted for simplicity.

As used herein, the term “base station” or “NodeB” may be considered synonymous to, and may hereafter be occasionally referred to, as a Node B, eNodeB, base transceiver station (BTS), etc. A base station describes a transceiver capable of providing wireless resources and services to mobile devices (e.g., mobile device 1042) in a wireless communication network spanning multiple technology generations. As discussed herein, base stations may have all functionally associated with conventional, well-known base stations in addition to the capability and functionality to perform the methods discussed herein.

Collectively, mobile devices and base stations may be referred to herein as “transceivers” or “radio frequency equipments.”

Returning to FIG. 1, the base station 106 includes a network-side control module 102. The functionality of the network-side control module 102 will be discussed in more detail later.

A public network 110 is communicatively coupled to the wireless network 100 to provide further communications links between devices. In one example, the public network 110 may be a core backhaul network including one or more packet (e.g., Internet Protocol (IP) or circuit (e.g., public switched telephone network (PSTN, plain old telephone system (POTS), etc.) switched networks providing data and/or voice communications links with other networks and/or end users.

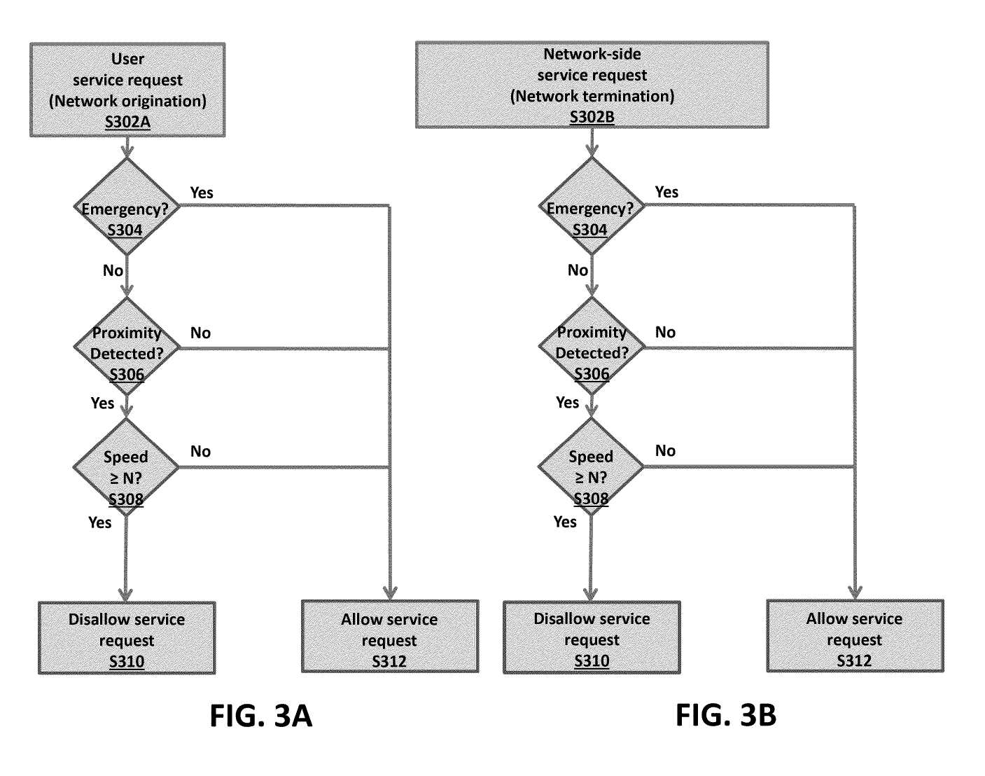

Embedded in FIG. 1 is a signal flow diagram illustrating example signal flow between the mobile device 1042 and the base station 106. The signal flow diagram will be discussed in more detail below with regard to the flow chart shown in FIG. 3A.

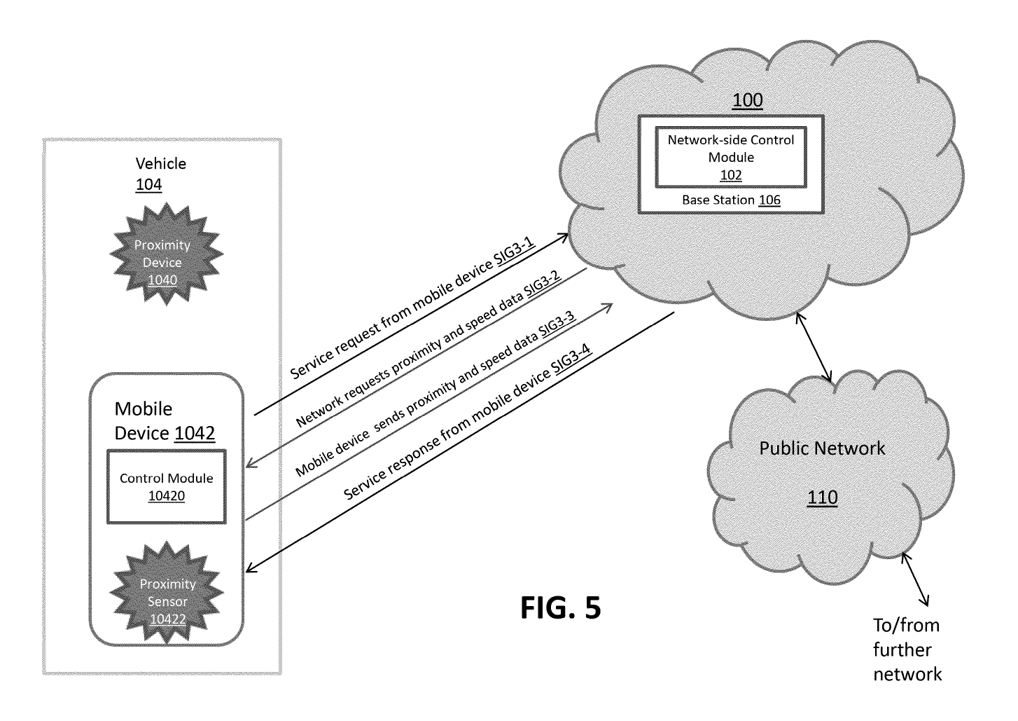

According to example embodiments, methods for network service access control for distracted driver lockout may be performed at the mobile device 1042 (e.g., by control module 10420) or at the network-side (e.g., by the network-side control module 102 at the base station 106). Example embodiments of methods for controlling network service access at the mobile device 1042 will be discussed with regard to FIGS. 1-4, whereas example embodiments of methods for controlling network service access at the network will be discussed with regard to FIGS. 5-7B. Although the example embodiments shown in FIGS. 5-7B will be described as being implemented at the base station 106, it should be understood that the described functionality may be implemented at other network elements (e.g., an RNC, etc.)

FIG. 3A is a flow chart illustrating an example embodiment of a method for controlling network service access. The method shown in FIG. 3A corresponds to the signal flow diagram embedded in FIG. 1. In the example embodiment described with regard to FIG. 1, the mobile device 1042 initiates the network service access request.

Referring to FIGS. 1 and 3A, at step S302A the control module 10420 detects a network service access request by a user of the mobile device 1042. In one example, initiation of a voice or data call by the user may be detected by the control module 10420.

In response to the network service access request, at step S304 the network access control module 10420 checks whether the network service access request is associated with an emergency situation. In one example, the network access control module 10420 checks whether the network service access request is associated with an emergency voice or data call.

Connections in a communications networks typically contain information that identifies the type of connection being requested. For example, e911 and Federal Emergency Management Agency (FEMA) type requests may include a “priority” indicator to establish a priority indicating that the network service access request is associated with an emergency, and to avoid blocking by the system. The network access control module 10420 may determine whether the network service access request is associated with an emergency by examining this or any other priority indicator.

In addition or alternatively, countries have specific numbers for emergencies (including for emergency calls and text messages), and the mobile device 1042 may be programmed with this information so that when a particular number is dialed, the mobile device 1042 is able to identify the connection as an emergency. In this example, the network access control module 10420 may determine whether the network service access request is associated with an emergency based on the number dialed.

If the network service access request is associated with an emergency situation, then the control module 10420 allows the network service access request at step S312. In this case, the mobile device 1042 transmits the network service access request message (SIG1) to the base station 106. In response to receiving the network service access request, the base station 106 processes the request in accordance with known emergency (or other) communications protocols to connect the mobile device 1042 if possible.

Returning to step S304 in FIG. 3A, if the network service access request is not associated with an emergency situation, then at step S306 the control module 10420 determines whether the mobile device 1042 is within range of the proximity device 1040 within the vehicle 104. In one example, if the proximity sensor 10422 detects the proximity device 1040, then the control module 10420 determines that the mobile device 1042 is within range of the proximity device 10422, and that the user of the mobile device 1042 is operating the vehicle 104.

If the proximity sensor 10422 does not detect the proximity device 1040, then the control module 10420 determines that the mobile device 1042 is not within range of the proximity device 1040.

If the control module 10420 determines that the mobile device 1042 is not within range of the proximity device 1040 at step S306, then the process proceeds to step S312 and continues as discussed above.

Returning to step S306, if the mobile device 1042 is within range of the proximity device 1040, then the control module 10420 compares the speed of the mobile device 1042 with a threshold value at step S308. This comparison may be made using Federal Communications Commission (FCC) mandated geo-location of the mobile device 1042 to determine when the vehicle 104 is moving faster than a given, desired or predetermined speed. In one example, either global positioning system (GPS) based geo-location or triangulation based geo-location may be used to determine the speed of the mobile device 1042, and the determined speed may be compared with a set speed threshold. The speed threshold may be set as desired based on, for example, federal or state law (e.g., if such law is enacted). Otherwise, the speed threshold may be set by the device manufacturer, parents, or other users/owners of the mobile device 1042.

If the speed of the mobile device 1042 is less than the threshold value, then the process proceeds to step S312 and continues as discussed above.

Returning to step S308, if the speed of the mobile device 1042 is greater than or equal to the threshold value, then at step S310 the control module 10420 prevents the mobile device 1042 from transmitting the network service access request message (SIG1) to the base station 106 thereby the restricting network service access by the mobile device 1042. The control module 10420 may prevent the mobile device 1042 from transmitting the network service request message to the base station 106 by inhibiting the RF transmitter (not shown) from transmitting the message to the base station 106. The control module 10420 may alert the user that the connection is being blocked using a visual or audible distinctive alert signal. In this case, the mobile device 1042 is not allowed to access the requested network service.

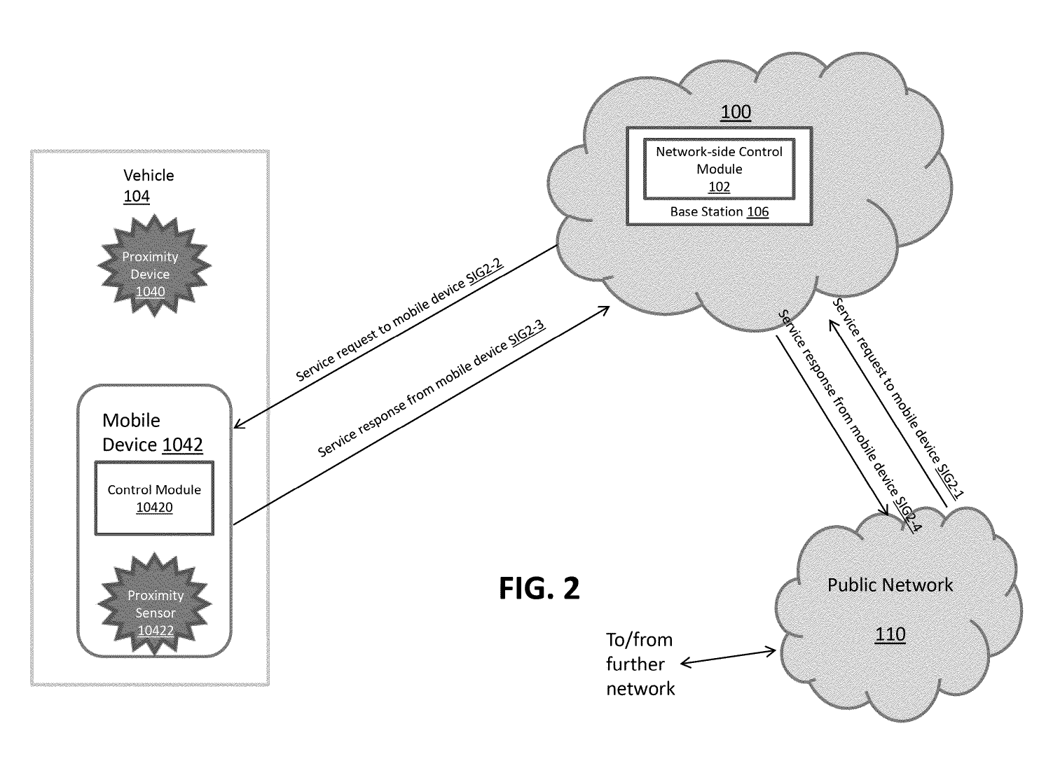

FIG. 2 illustrates a portion of a network architecture including a signal flow diagram illustrating a method for controlling network service access according to another example embodiment.

FIG. 3B is a flow chart illustrating an example embodiment of a method for controlling network service access. The method shown in FIG. 3B corresponds to the signal flow diagram embedded in FIG. 2. In the example embodiment described with regard to FIG. 2, the network service access request is initiated at or prior to the public network 110.

In the example embodiment shown in FIGS. 2 and 3B, the base station 106 receives a network service access request message (SIG2-1) from the public network 110 and forwards the received request message to the mobile device 1042 (SIG2-2).

At step S302B, the mobile device 1042 receives the network service access request message from the base station 106. In one example, the network service access request message may include a request for network termination at (e.g., voice and/or data call with) the mobile device 1042.

In response to receiving the network service access request message, at step S304 the control module 10420 checks whether the network service access request is associated with an emergency situation in the same manner as discussed above with regard to FIGS. 1 and 3A.

If the network service access request is associated with an emergency situation, then the control module 10420 allows network termination at the mobile device 1042 at step S312. In this case, the mobile device 1042 transmits a network service access response message (SIG2-3) to the base station 106 indicating that network termination at the mobile device 1042 is allowable. The base station 106 forwards the network service access request response message (SIG2-4) to the public network 110 informing the originating network/user that the mobile device 1042 is available for connection.

Returning to step S304, if the network service access request is not associated with an emergency situation, then at step S306 the control module 10420 determines whether the mobile device 1042 is within range of the proximity device 1040 as discussed above with regard to FIGS. 1 and 3A.

If the control module 10420 determines that the mobile device 1042 is not within range of the proximity device 1040 at step S306, then the process proceeds to step S312, and continues as discussed above.

Returning to step S306, if the mobile device 1042 is within range of the proximity device 1040, then the control module 10420 determines whether the speed of the vehicle 104 is greater than or equal to the threshold value as discussed above with regard to FIGS. 1 and 3A.

If the speed of the mobile device 1042 is less than the threshold value, then the process proceeds to step S312 and continues as discussed above.

Returning to step S308, if the speed of the mobile device 1042 is greater than or equal to the threshold value, then at step S310 the control module 10420 restricts network service access by the mobile device 1042; that is, network termination at the mobile device 1042 is denied. In this example, the control module 10420 generates a network service access request message SIG2-3 denying the network service access request originated from the public network 110. The base station 106 forwards the network service access request message (SIG2-4) to the public network 110 and no connection is created in response to the network service access request message (SIG2-1).

At steps S306 and S308 in FIGS. 3A and 3B, the mobile device 1042 controls network service access based on the movement of the mobile device 1042 while the mobile device 1042 is in range of the proximity device 1040.

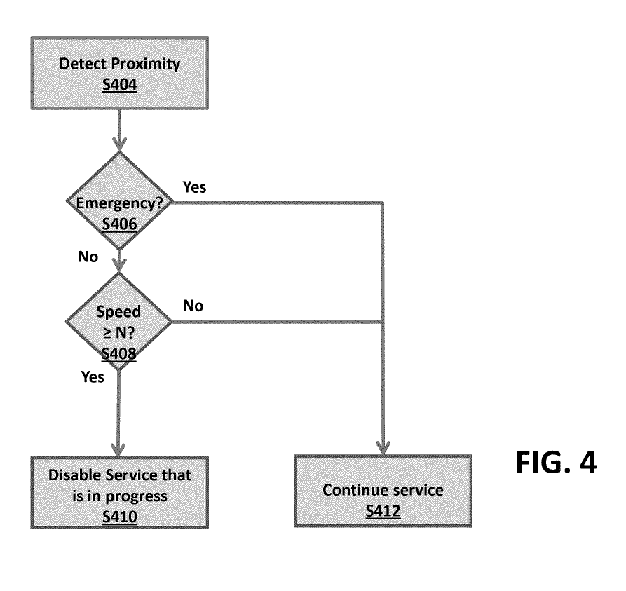

FIG. 4 is a flow chart illustrating a method for controlling network service access according to another example embodiment. The example embodiment shown in FIG. 4 is applicable to a situation in which the mobile device 1042 has already established network service access with (or via) the wireless network 100 (e.g., a voice or data call is in progress between the mobile device 1042 and another user or device). The method shown in FIG. 4 will again be described with regard to FIG. 1 for example purposes.

Referring to FIGS. 1 and 4, during a network service session, when the mobile device 1042 comes within range of the proximity device 1040, the control module 10420 detects the proximity device 1040 via the proximity sensor 10422 (step S404).

The control module 10420 may monitor (e.g., continuously or intermittently) the in-progress connection to determine if there has been any change in the state of the proximity detection or speed after the connection has been accepted and/or established.

In response to detecting the proximity device 1040 at step S404, the mobile device 1042 checks whether the network service session is associated with an emergency situation in the same manner as discussed above with regard to FIGS. 1-3B.

If the network service session is associated with an emergency situation, then the control module 10420 allows the mobile device 1042 to continue the network service session at step S412.

Returning to step S406, if the network service session is not associated with an emergency situation, then at step S408 the control module 10420 determines whether the vehicle 104 is moving faster than a given, desired or predetermined threshold value for speed as discussed above with regard to FIGS. 1-3B.

If the speed of the mobile device 1042 is less than the threshold value, then the process proceeds to step S412 and continues as discussed above.

Returning to step S408, if the speed of the mobile device 1042 is greater than or equal to the threshold value, then at step S410 the control module 10420 disables the in-progress network service session. In one example, at step S410 the control module 10420 may disconnect an in-progress voice and/or data call.

According to at least some other example embodiments, the network access service control may be performed at the network side. In at least one example embodiment, the network service access control by the mobile device 1042 may be controlled by a network-side control module 102 at the base station 106.

In the method shown in FIG. 4, the mobile device 1042 controls network service access based on the movement of the mobile device 1042 while the mobile device 1042 is in range of the proximity device 1040.

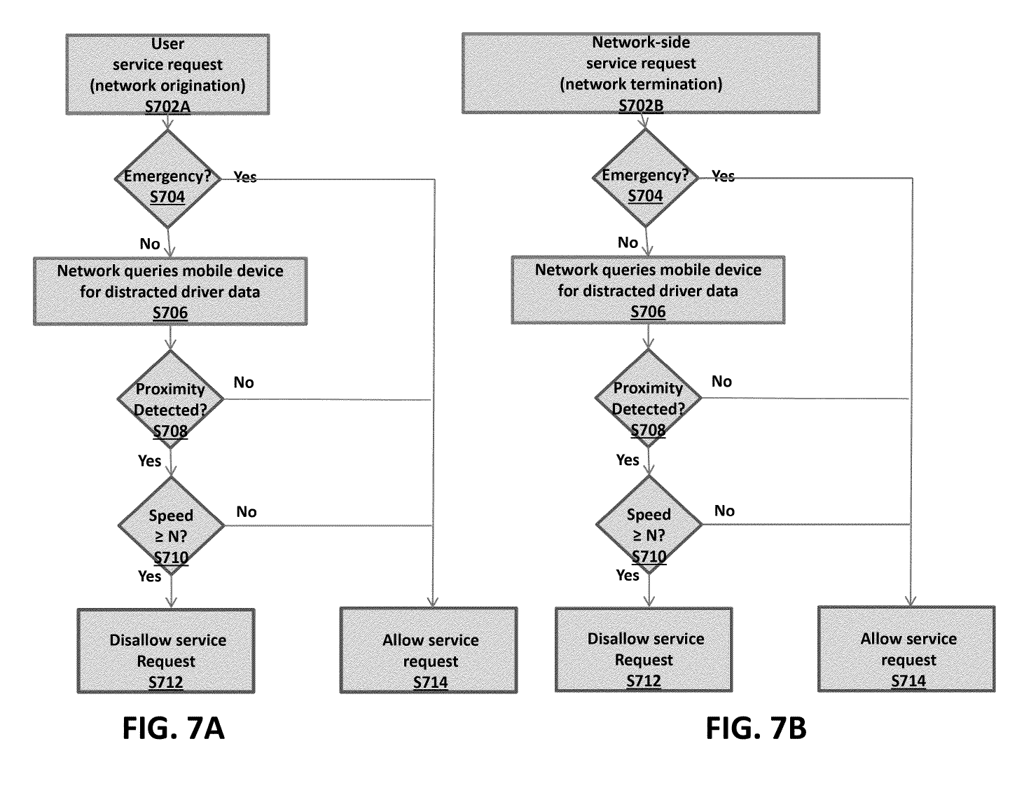

FIG. 5 illustrates a portion of a network architecture including a signal flow diagram illustrating a method for controlling network service access at the network according to an example embodiment. FIG. 7A is a flow chart illustrating an example embodiment of a method for service access control at the network. The signal flow diagram shown in FIG. 5 corresponds to the flow chart shown in FIG. 7A. The operations discussed with regard to FIG. 7A will be discussed as being performed by the network-side control module 102 shown in FIG. 5.

Referring to FIGS. 5 and 7A, at step S702A the network-side control module 102 receives a network service access request message (SIG3-1) from the mobile device 1042 (network origination). In one example, the network service access request message may be or include a request for a voice and/or data connection via the base station 106.

In response to the network service access request message from the mobile device 1042, the network-side control module 102 checks whether the network service access request is associated with an emergency situation. The network-side control module 102 may determine whether the network service access request is associated with an emergency by examining the priority indicator or based on the number dialed as discussed above with regard to FIGS. 1-4.

If the network service access request is associated with an emergency situation, then at step S714 the network-side control module 102 transmits a network service access response (SIG3-4) to the mobile device 1042 allowing the network origination by the mobile device 1042. The base station 106 then connects the mobile device 1042 to the requested network service.

Returning to step S704, if the network service access request is not associated with an emergency situation, then at step S706 the network-side control module 102 obtains distracted driver information/data from the mobile device 1042.

As discussed herein, distracted driver information/data may include proximity and speed information/data as discussed above with regard to FIGS. 1-4. That is, for example, the distracted driver information/data may include an indication of whether the mobile device 1042 is within range of the proximity device 1040, and a speed (e.g., current, instantaneous, average, etc.) of the mobile device 1042. In one example, at step S706 the network-side control module 102 transmits a distracted driver information/data request message (SIG3-2) to the mobile device 1042. In response to the distracted driver information request message, the mobile device 1042 transmits a distracted driver information/data message (SIG3-3) to the network-side control module 102.

After obtaining the distracted driver information/data from the mobile device 1042, at step S708 the network-side control module 102 determines whether the mobile device 1042 is within range of the proximity device 1040 based on the received distracted driver information/data.

If the mobile device 1042 is not within range of the proximity device 1040, then the process proceeds to step S714 and continues as discussed above.

Returning to step S708, if the mobile device 1042 is within range of the proximity device 1040, then at step S710 the network-side control module 102 determines whether the mobile device 1042 is moving at a speed that is greater than or equal to a threshold value. The threshold may be the same as the threshold discussed above, but may be set by a network operator according to applicable laws or other information. In one example, the network-side control module 102 compares the speed information received from the mobile device 1042 with the threshold value.

If the speed of the mobile device 1042 is less than the threshold value, then the process proceeds to step S714 and continues as discussed above.

Returning to step S710, if the speed of the mobile device 1042 is greater than or equal to the threshold value, then at step S712 the network-side control module 102 transmits a network service access response (SIG3-4) to the mobile device 1042 denying the network origination by the mobile device 1042. In this case, the connection by the mobile device 1042 is denied.

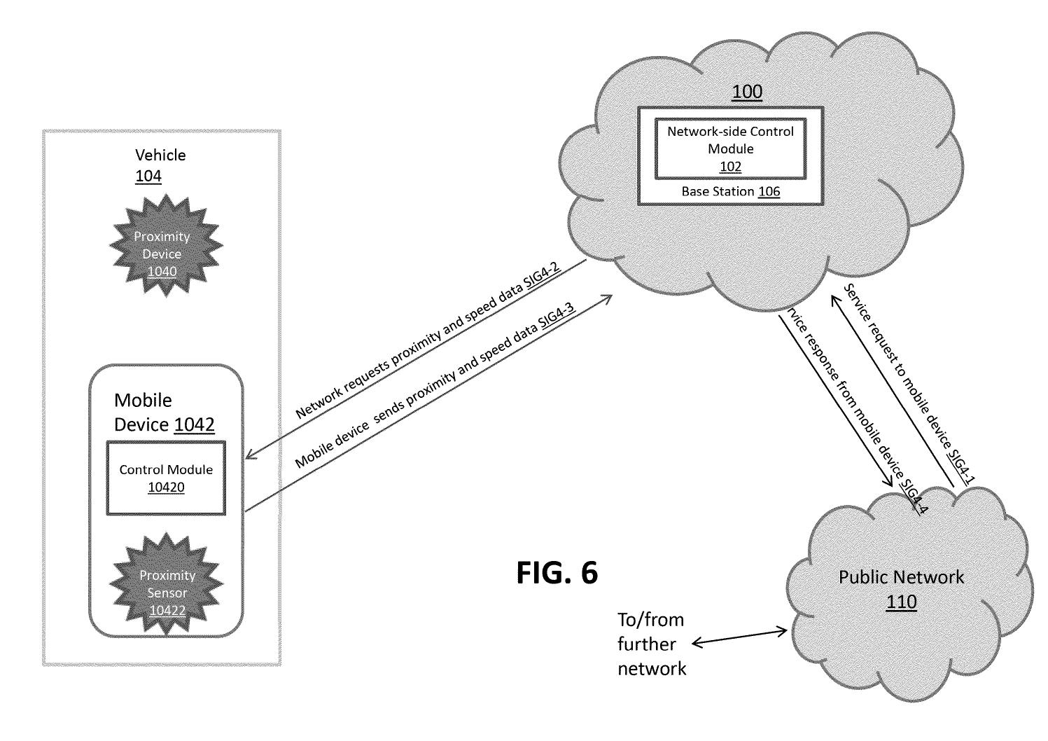

FIG. 6 illustrates a portion of a network architecture including a signal flow diagram illustrating a method for controlling network service access at the network according to an example embodiment.

FIG. 7B is a flow chart illustrating an example embodiment of a method for network service access control at the network. The signal flow diagram shown in FIG. 6 corresponds to the flow chart shown in FIG. 7B. The operations discussed with regard to FIG. 7B will be discussed as being performed by the network-side control module 102 shown in FIG. 6.

FIGS. 6 and 7B illustrate a situation in which a network service access request for the mobile device 1042 is originated at or prior to the public network 110. In this example, the network service access request involves network termination at the mobile device 1042.

Referring to FIGS. 6 and 7B, at step S702B the network-side control module 102 receives a network service access request message (SIG4-1) from the public network 110. In one example, the network service access request message may be or include a request for network termination at (e.g., voice and/or data call with) the mobile device 1042.

In response to the network service access request message from the mobile device 1042, the network-side control module 102 checks whether the network service access request is associated with an emergency situation as discussed above with regard to FIGS. 5 and 7A.

If the network service access request is associated with an emergency situation, then at step S714 the network-side control module 102 transmits a network service access response message (SIG4-4) to the mobile device 1042 allowing the network termination at the mobile device 1042. The base station 106 then connects the network service to the mobile device 1042 accordingly.

Returning to step S704, if the network service access request is not associated with an emergency situation, then at step S706 the network-side control module 102 obtains distracted driver information/data from the mobile device 1042. In one example, at step S706 the network-side control module 102 transmits a distracted driver information/data request message (SIG4-2) to the mobile device 1042. In response to the distracted driver information/data request message, the mobile device 1042 transmits a distracted driver information/data message (SIG4-3) to the network-side control module 102. The distracted driver information/data request message (SIG4-2) and the distracted driver information/data message (SIG4-3) are the same as the distracted driver information/data request message (SIG3-2) and the distracted driver information/data message (SIG3-3), respectively, discussed above with regard to FIG. 5.

After obtaining the distracted driver information/data from the mobile device 1042, at step S708 the network-side control module 102 determines whether the mobile device 1042 is within range of the proximity device 1040 based on the received distracted driver information/data as discussed above with regard to FIGS. 5 and 7A.

If the mobile device 1042 is not within range of the proximity device 1040, then the process continues to step S714 and proceeds as discussed above.

Returning to step S708, if the mobile device 1042 is within range of the proximity device 1040, then at step S710 the network-side control module 102 determines whether the mobile device 1042 is moving at a speed that is greater than or equal to a threshold value as discussed above with regard to FIGS. 5 and 7A.

If the speed of the mobile device 1042 is less than the threshold value, then the process proceeds to step S714 and continues as discussed above.

Returning to step S710, if the speed of the mobile device 1042 is greater than or equal to the threshold value, then at step S712 the network-side control module 102 transmits a network service access response message (SIG4-4) to the public network 110 indicating that network termination at the mobile device 1042 has been denied. In this situation, network service is not provided with the mobile device 1042.

Although steps S708 and S710 are shown as sequential in FIGS. 7A and 7B, it should be understood that the order of these operations may be reversed, the operations may be performed concurrently and/or simultaneously, or these operations may be combined into a single operation in which the network-side control module 102 determines whether both conditions are met in order to determine whether to allow or deny network service access by/to the mobile device 1042.

At least some example embodiments provide a mechanism to disable a motor vehicle operator's mobile device from functioning when inside a vehicle based on movement of the vehicle and mobile device as well as the mobile device's proximity to a proximity device.

Inhibiting an electronic device that can distract the driver while operating a motor vehicle may enhance road or other travel safety.

Example embodiments place control logic into the mobile device and/or the base station, network controller, etc. Alternatively, however, control logic may be integrated into the vehicle itself. In this example, the vehicle itself may provide the proximity and speed triggers.

The foregoing description of example embodiments has been provided for purposes of illustration and description. It is not intended to be exhaustive or to limit the disclosure. Individual elements or features of a particular example embodiment are generally not limited to that example embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

We claim:

1. A method for controlling network service access by a mobile device, the method comprising:
detecting, by the mobile device, a proximity device within range of the mobile device; and
controlling, by the mobile device, network service access based on movement of the mobile device while the mobile device is within range of the proximity device.

2. The method of claim 1, wherein the controlling comprises:
selectively restricting the network service access by the mobile device based on a speed of the mobile device and a threshold value.

3. The method of claim 2, further comprising:
comparing the speed of the mobile device with the threshold value; wherein
the selectively restricting restricts network service access if the speed is greater than or equal to the threshold value.

4. The method of claim 2, further comprising:
determining whether the network service access is associated with an emergency call or situation; and
allowing network service access independent by the mobile device if the network service access is associated with an emergency call or situation.

5. The method of claim 2, further comprising:
comparing the speed of the mobile device with the threshold value; and
allowing network service access if the speed is less than the threshold value.

6. The method of claim 1, wherein the controlling comprises:
selectively disabling network service access by the mobile device based on a speed of the mobile device and a threshold value.

7. The method of claim 6, further comprising:
comparing the speed of the mobile device with the threshold value; wherein
the selectively disabling disables the network service access if the speed is greater than or equal to the threshold value.

8. The method of claim 7, further comprising:
determining whether the network service access is associated with an emergency call or situation; and
allowing network service access by the mobile device if the network service access is associated with an emergency call or situation.

9. The method of claim 1, wherein the detecting is performed in response to a network service request by the mobile device.

10. The method of claim 1, wherein the detecting is performed in response to a network service request received at the mobile device.

11. The method of claim 1, wherein the proximity device is located within a vehicle.

12. A method for controlling network service access by a mobile device, the method comprising:
obtaining, at a network entity, distracted driver information associated with the mobile device in response to a network service access request, the distracted driver information including movement information for the mobile device;
determining whether the mobile device is within range of a proximity device; and
controlling network service access by the mobile device based on the distracted driver information associated with the mobile device while the mobile device is within range of the proximity device.

13. The method of claim 12, wherein the movement information includes a speed of the mobile device, and wherein the controlling includes,
selectively restricting network service access by the mobile device based on the speed of the mobile device and a threshold value.

14. The method of claim 13, further comprising:
comparing the speed of the mobile device with the threshold value; wherein
the selectively restricting restricts network service access if the speed is greater than or equal to the threshold value.

15. The method of claim 13, further comprising:
comparing the speed of the mobile device with the threshold value; and
allowing network service access if the speed is less than the threshold value.

16. The method of claim 12, further comprising:
determining whether the network service access request is associated with an emergency call or situation; and
allowing network service access by the mobile device if the network service access request is associated with an emergency call or situation.

17. The method of claim 12, wherein the network service access request is from the mobile device.

18. The method of claim 12, wherein the network service request is from the network.

19. The method of claim 12, wherein the proximity device is located within a vehicle.

20. An apparatus for controlling network service access at a mobile device, the apparatus comprising:
a proximity sensor configured to detect a proximity device within range of the mobile device; and
a control module configured to control network service access based on movement of the mobile device while the mobile device is within range of the proximity device.
